(19) United States
(12) Patent Application Publication
(10) Pub. No.: US 2020/0364628 A1
(43) Pub. Date: Nov. 19, 2020

(54) PARALLEL VERSIONING AND MULTI-VARIATE TESTING

(71) Applicant: Amadeus S.A.S., Biot (FR)

(72) Inventors: Hugues Gabriel, Antibes (FR); Corinne Joumard, Valbonne (FR); Dorin Pomian, Antibes (FR); Antoine De Kerviler, Mougins (FR)

(21) Appl. No.: 16/856,709

(22) Filed: Apr. 23, 2020

(30) Foreign Application Priority Data
May 17, 2019 (FR) 1905172

(51) Int. Cl. G06Q 10/02; G06F 9/54; G06F 16/9538; G06Q 50/14; G06F 11/36

(52) U.S. Cl. CPC G06Q 10/025; G06F 9/54; G06F 11/368; G06Q 50/14; G06F 16/9538

(57) ABSTRACT

Systems, methods, and computer-readable storage media for testing parallel versions of content in a distributed computing environment using unique identifiers corresponding to search queries. A search query including search parameters is received from a client device. A unique identifier corresponding to the search query is determined. One version of a fare set among a plurality of versions of the fare set is accessed based on the unique identifier. Each version of the fare set among the plurality of versions of the fare set is distinct from the other versions of the fare set by virtue of a variant. Each variant is stored in a corresponding child file. Fare data is retrieved from the accessed version of the fare set. A search result is populated with pricing information for a travel itinerary that satisfies the plurality of search parameters using the retrieved fare data and transmitted to the client device.

### TECHNICAL FIELD

The present invention relates generally to a distributed computing environment, although not limited thereto. More specifically, the present invention relates to systems, methods, and computer-readable storage media for testing parallel versions of content in a distributed computing environment.

### BACKGROUND

Controlled experiments, such as A|B testing, enable updates to current content or new content to be objectively evaluated while minimizing the risks associated with full deployment. In A|B testing, for example, an update to a current version of content or new content being tested (hereinafter “version B”) may be objectively evaluated against a current version (hereinafter “version A”). Users interacting with the content under test may be partitioned such that a first subset of the users is presented with version A while a second subset of the users is presented with version B. Evaluation metrics may be determined for each version using data collected regarding responses or behaviors of users in the first and second subsets. Such evaluation metrics facilitate objectively evaluating version B against version A.

Various challenges exist for content providers implementing such controlled experiments in distributed computing environments. One challenge involves correlating test partitions with subsequent responses or outcomes to obtain data for generating evaluation metrics. For example, a request for content being tested and a transaction concerning that content may be received by a server providing that content through different channels even though the request and the transaction may ultimately originate from the same user. This instance generally occurs in distributed computing environments involving intermediate devices (e.g., application servers, search websites, terminal servers, and the like) through which users may access the content being tested.

Another challenge arises when a content provider attempts to test multiple versions of content in parallel. For example, instead of testing versions A and B, the content provider may attempt to test version C. In response to received evaluation metrics, the content provider may identify particular aspects of versions B and C that represent improvements over version A and particular aspects of versions B and C perform worse than corresponding aspects of version A. Selectively merging the particular aspects of versions B and C that represent improvements over version A for further testing while discarding the particular aspects of versions B and C that perform worse than version A may not be possible under existing techniques. Moreover, rolling back any changes introduced into the various versions during testing is generally challenging.

### SUMMARY

Embodiments of the present invention provide systems, methods, and computer-readable storage media for independently evolving and testing parallel versions of content in a distributed computing environment. In an embodiment of the present invention, a method includes receiving a search query including a plurality of search parameters from a client device. A search result that satisfies the plurality of search parameters is identified. A unique identifier associated with the search query is determined. Based on the unique identifier, one version of content among a plurality of version of the content is accessed. Each version of the content among the plurality of versions of the content is distinct from the other versions by virtue of a variant. Each variant is stored in a corresponding child file. Content data is retrieved from the accessed version of the content. A search result that satisfies the plurality of search parameters is populated with relevant information using the retrieved content data and transmitted to the client device in response to the search query.

In another embodiment, a system includes a computing device and computer-readable storage medium comprising a first set of instructions that upon execution by the computer device cause the system to perform operations. The operations include receiving a search query including a plurality of search parameters from a client device. A unique identifier corresponding to the search query is determined. Based on the unique identifier, one version of content among a plurality of versions of the content is accessed. Each version of the content among the plurality of versions of the content is distinct from the other versions by virtue of a variant. Each variant is stored in a corresponding child file. Content data is retrieved from the accessed version of the content. A search result that satisfies the plurality of search parameters is populated with relevant information using the retrieved content data and transmitted to the client device in response to the search query.

In another embodiment, a non-transitory computer-readable storage medium includes computer-readable instructions that upon execution by a processor of a computing device cause the computing device to perform operations. The operations include receiving a search query including a plurality of search parameters from a client device. A unique identifier corresponding to the search query is determined. Based on the unique identifier, one version of content among a plurality of versions of the content is accessed. Each version of the content among the plurality of versions of the content is distinct from the other versions by virtue of a variant. Each variant is stored in a corresponding child file. Content data is retrieved from the accessed version of the content. A search result that satisfies the plurality of search parameters is populated with relevant information using the retrieved content data and transmitted to the client device in response to the search query.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, serve to explain the embodiments of the invention. In the drawings, like reference numerals are used to indicate like parts in the various views.

FIG. 1 is a block diagram of an example distributed computing environment that is suitable for implementing embodiments of the present invention.

FIG. 2 is a block diagram of an example reservation system that is suitable for implementing embodiments of the present invention.

FIG. 3 depicts a high-level illustration of parallel content versioning in accordance with an embodiment of the present invention.

FIG. 4 depicts a high-level illustration of a data structure that is suitable for implementing parallel content versioning in accordance with an embodiment of the present invention.

FIG. 5 illustrates an example of relationships between a base fare set and variants of the base fare set in accordance with an embodiment of the present invention.

FIG. 6 depicts a Venn diagram for illustrating the performance of set operations on parallel content versions in accordance with an embodiment of the present invention.

FIG. 7 is a flow-chart illustrating an example of a method for concurrently testing parallel versions of content in a distributed computing environment.

FIG. 8 is a block diagram of an example computing environment suitable for use in implementing embodiments of the invention.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

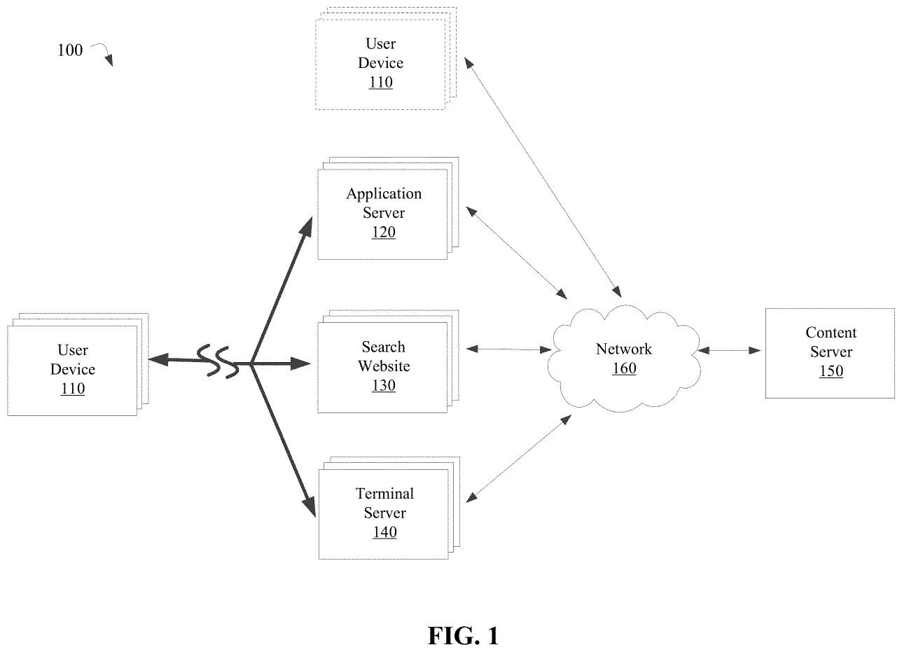

Referring to FIG. 1, an example operating environment 100 for implementing aspects of the present invention is illustrated and designated generally 100. In general, operating environment 100 represents the various systems and distribution channels through which users access content provided by a content provider. Operating environment 100 includes user device 110, application server 120, search website 130, terminal server 140, and content server 150. As depicted in FIG. 1, the various systems communicate with each other via network 160, which may include one or more public and/or private networks. Examples of networks that are suitable for implementing network 160 include: local area networks (“LANs”), wide area networks (“WANs”), cellular network, the Internet, and the like.

In operation, a user interacts with user device 110 to access content provided by content server 150 via network 160. As seen in FIG. 1, many distribution channels exist within operating environment 100 through which the user may access the content provided by content server 150. For example, user device 110 may directly access the content by communicating a request for the content directly to content server 150 via network 160. User device 110 may also indirectly access the content by first communicating a request for the content to an intermediate device. The intermediate device may be application server 120, search website 130, and/or terminal server 140. Upon receiving that request, intermediate device may communicate a request for the content to content server 150. In response, content server 150 returns the requested content to the intermediate device which forwards the requested content to user device 110. Alternatively, upon receiving the request for content from user device 110, the intermediate device may return a cached version of the requested content to user device 110. In this instance, the intermediate device may have retrieved the requested content from content server 150 prior to receiving the request from user device 110 and stored that content in local cache storage to reduce response times.

When user device 110 receives the requested content, the user may execute a transaction concerning the requested content. For example, the user may initiate a transaction to obtain content related to the requested content or initiate a transaction to purchase the requested content. Again, many distribution channels exist within operating environment 100 through which the user may execute a transaction concerning the requested content. User device 110 may directly execute the transaction with content server 150 via network 160. If an intermediate device provided user device 110 with the requested content, user device 110 may indirectly execute a first transaction concerning the requested content with the intermediate device. The intermediate device may then directly execute a second transaction concerning the requested content with content server 150. Alternatively, the intermediate device may have provided user device 110 with instructions to establish a communication session with content server 150 in order to execute a transaction when providing the requested content. In this instance, user device 110 may directly execute the transaction concerning the requested content with content server 150 based on those instructions.

One skilled in the art will recognize that in accessing content provided by content server 150 or initiating a transaction concerning such content, a particular client initiates a communication session with a particular component of the distributed computing network. Briefly, a “communication session” in example embodiments of the present disclosure refers to an information exchange flow between a server node and a client node in a client-server architecture. The information exchange flow typically involves the client node sending the server node a request that the server node processes and returns a response that satisfies the request to the client node. In an embodiment, a communication session may be implemented as a hypertext transfer protocol (“HTTP”) session over a Transmission Control Protocol (TCP) connection.

From the perspective of content server 150, each of the requests for content and transactions in the examples above may originate from different client nodes. In the example where user device 110 directly accesses the content, user device 110 is the client node of that communication session. In the example, where user device 110 indirectly accesses the content by first communicating a request for the content to an intermediate device, the intermediate device (e.g., application server 120, search website 130, and/or terminal server 140) is the client node of that communication session since the intermediate device is communicating a request for the content to content server 150. In the example, where user device 110 indirectly accesses the content via the intermediate device and then subsequently directly executes the transaction with content server 150, the request and the transaction originate from different client nodes (i.e., the intermediate device and user device 110, respectively) even though the request and transaction both ultimately originate from user device 110.

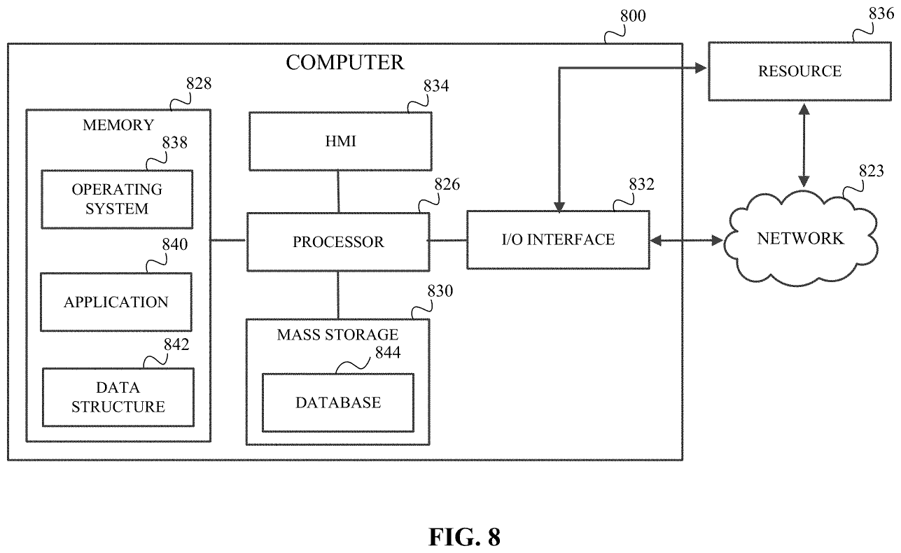

Each of the systems shown in FIG. 1 may be implemented via any type of computing system, such as computing system 800 described in greater detail below with respect to FIG. 8, for example. Each system shown in FIG. 1 may comprise a single device or multiple devices cooperating in a distributed environment. For instance, content server 150 may be provided via multiple devices arranged in a distributed environment that collectively provide the functionality described herein. Additionally, other components not shown may also be included within the distributed environment.

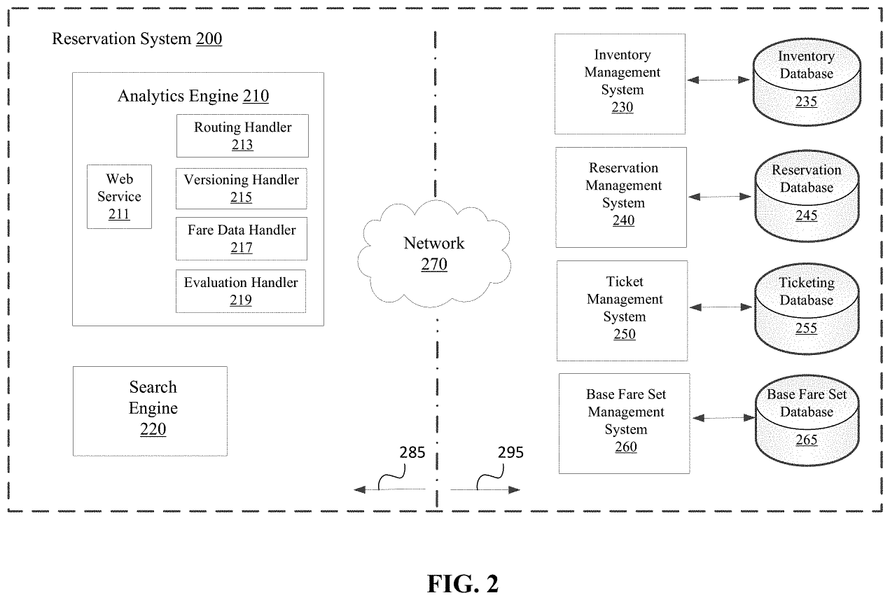

FIG. 2 is a block diagram of an example reservation system 200 that is suitable for implementing aspects of the present invention. In an embodiment, reservation system 200 is implemented in content server 150 of FIG. 1. As depicted in FIG. 2, reservation system 200 includes front-end systems 285 and back-end systems 295 that exchange data via a network 270 composed of public and private networks, such as the Internet and a reservation system intranet. Front-end systems 285, such as search engine 220, interact directly with client devices (e.g., user device 110, application server 120, search website 130, and/or terminal server 140 of FIG. 1) during a travel reservation process.

In contrast, client devices are not exposed to back-end systems 295 that store data related to travel services (“travel-related data”) and effectuate services related to booking travel services (“travel-related services”). In FIG. 2, the travel-related services in reservation system 200 include travel-related services provided by inventory management system 230, reservation management system 240, ticket management system 250, and base fare set management system 260. Examples of travel-related data include inventory data, fare data, routing data, scheduling data, check-in data, boarding data, and the like. Examples of travel-related services include reserving travel services that define an itinerary, ticketing the reserved travel services that define an itinerary, and the like. For the purposes of the present disclosure, an “itinerary” refers to a structured travel route between an origin location and a destination location. In an embodiment, travel-related data corresponds to the content provided by content server 150 in FIG. 1.

Analytics engine 210 is configured to facilitate testing and managing parallel versions of content in a distributed computing environment. Analytics engine 210 includes web service 211, routing handler 213, versioning handler 215, fare set handler 217, and evaluation handler 219. Web service 211 is configured to facilitate networked communications between front-end systems 285 of reservation system 200 (e.g., search engine 220) and clients of reservation system 200. For example, during a search phase of a travel reservation process, a search query submitted by a client device is directed to search engine 220 via web service 210.

Routing handler 213 is configured to determine a unique identifier corresponding to each search query submitted by a client device to web service 211 in accordance with predefined partitioning rules. In an embodiment, a unique identifier corresponding to a search query received from a client device is determined based on a plurality of search parameters included in the search query, user login credentials, an account identifier, a machine identifier of the client device, a network address of the client device, a geographic location of the client device, or a combination thereof. Routing handler 213 is further configured to interact with search engine 220 to identify one or more search results comprising a travel itinerary that satisfies the plurality of search parameters.

When the one or more search results are identified, routing handler 213 interacts with fare set handler 217 to obtain pricing information for travel itineraries included in the one or more search results. Based on an evaluation of the unique identifier with the predefined portioning rules, routing handler 213 derives a value corresponding to a particular version of a fare set that fare set handler 217 is to access to obtain the pricing information. Routing handler 213 transmits the value to fare set handler 217 and in response receives the pricing information. In an embodiment, routing handler 213 caches search-related data that associates the unique identifier, the search query, the accessed version of the fare set, the search response, or a combination thereof in a storage device associated with reservation system 200.

Versioning handler 215 is configured to manage modified fare sets in support of parallel content versioning, as described in greater detail below. Fare set compiler 217 is configured to retrieve pricing information for travel itineraries included in the one or more search results identified by search engine 220 using a value received from routing handler 213 that corresponds to a particular version of a fare set that fare set handler 217 is to access to obtain the pricing information. In one embodiment, fare set handler 217 accesses base fare set database via base fare set management system 260 to obtain pricing information when the particular version of the fare set is a base fare set. In one embodiment, fare set handler 217 forwards the value to versioning handler 215 to obtain pricing information when the value corresponds to a modified version of the fare set. Upon obtaining pricing information for travel itineraries, fare set handler 217 forwards that information to routing handler 213 for further processing.

Evaluation handler 219 is configured to correlate reservation records with particular versions of a fare set that were accessed in populating search results with pricing information. By making that correlation, evaluation handler 219 is able to compile evaluation data. Based on the evaluation data, evaluation handler 219 determines an evaluation metric, such as a conversion rate, for each version of the fare set among the plurality of versions of the fare set. As such, each version of the fare set among the plurality of versions of the fare set may be objectively evaluated using evaluation metrics determined for each version using compiled evaluation data. Based on that objective evaluation, a determination may be made that clients respond more positively to a first version of a fare set than a second version of the fare set.

Search engine 220 is configured to identify search results having at least one itinerary that satisfies search parameters included in each search query. Examples of such search parameters may include: an origin location, a destination location, a departure date, a return date, a number of passengers associated with a travel request (“a number in party”), a booking class, a number of stops, a rail segment number, a travel provider identifier, a cabin class (e.g., First Class or Economy), a fare family, a departure hour range, and the like. Search engine 220 is further configured to communicate identified search results to the client devices via web service 210.

Inventory-related data for one or more travel service providers is stored in inventory database 235 under the control of inventory management system 230. In an embodiment, inventory-related data includes availability information that defines unreserved travel services inventory. As used herein, “unreserved travel services inventory” relates to portions of a travel services inventory that are not associated with any reservation records stored in reservation database 245. In contrast, “reserved travel services inventory” relates to portions of a travel services inventory that are associated with one or more reservation records stored in reservation database 245.

Reservation records for one or more travel service providers are stored in reservation database 245 under the control of reservation management system 240. Reservation management system 240 is configured to interact with search engine 220 to process reservation requests received during a booking phase of a travel reservation process. In response to receiving a reservation request identifying a travel itinerary, reservation management system 240 generates a reservation record in reservation database 245. In an embodiment, the reservation record is a passenger name record (“PNR”). The reservation record includes itinerary data and a record locator that uniquely identifies the reservation record in reservation database 245. In an embodiment, the reservation record includes a ticketing time limit. The record locator may also be referred to as a confirmation number, reservation number, confirmation code, booking reference, a PNR number, and the like.

Itinerary data generally includes travel information defining various travel services included in an itinerary and passenger information related to one or more passengers associated with the reservation record. Examples of travel information include: an origin location, a destination location, a departure date, a return date, a number in party, a booking class, a number of stops, a flight number, a travel provider identifier, a cabin class, and the like. Examples of passenger information, for each passenger among the one or more passengers associated with a reservation record, include: name, gender, date of birth, citizenship, home address, work address, passport information, an e-mail address, a phone number, a special service request (“SSR”), and the like.

Ticket records for one or more travel service providers are stored in ticketing database 255 under the control of ticket management system 250. Ticket management system 250 is configured to interact with search engine 220, inventory management system 230, and reservation management system 240 to process ticket issuance requests received during a ticketing phase of a travel reservation process. In processing ticket issuance requests, ticket management system 250 generates ticket records in ticketing database 255 for each travel service segment (“segment”) and each passenger associated with the reserved travel itinerary using travel information and passenger information in the reservation record.

For example, a reservation record may include passenger information related to two passengers. The reservation record may further include travel information defining two rail travel segments for travel from an origin location to a destination location via a stopover location and one rail travel segment for travel from the destination location to the origin location. In this example, the travel information defines three total rail travel segments for two passengers. In response to receiving a ticket issuance request associated with the reservation record in this example, ticket management system 250 would generate six ticket records in ticketing database 255. Ticket management system 250 would submit a request to reservation management system 240 to update the reservation record stored in reservation database 245 to include six ticket numbers that identify each ticket record generated. That is, in this example, a single reservation record stored in reservation database 245 would include ticket numbers identifying six ticket records stored in ticketing database 255.

Unmodified fare sets are stored in base fare set database 265 under the control of base fare set management system 260. Base fare set management system 260 is configured to interact with travel provider systems via a network (e.g., network 160 of FIG. 1) to ensure that fare data stored in base fare set database 265 is synchronized with fare data residing on the travel provider systems. In an embodiment, the travel provider systems push fare data updates to base fare set database 265 via base fare set management system 260. In an embodiment, base fare set management system 260 periodically queries data structures residing on the travel provider systems to ensure that fare data stored in base fare set database 265 is synchronized with fare data residing on the travel provider systems.

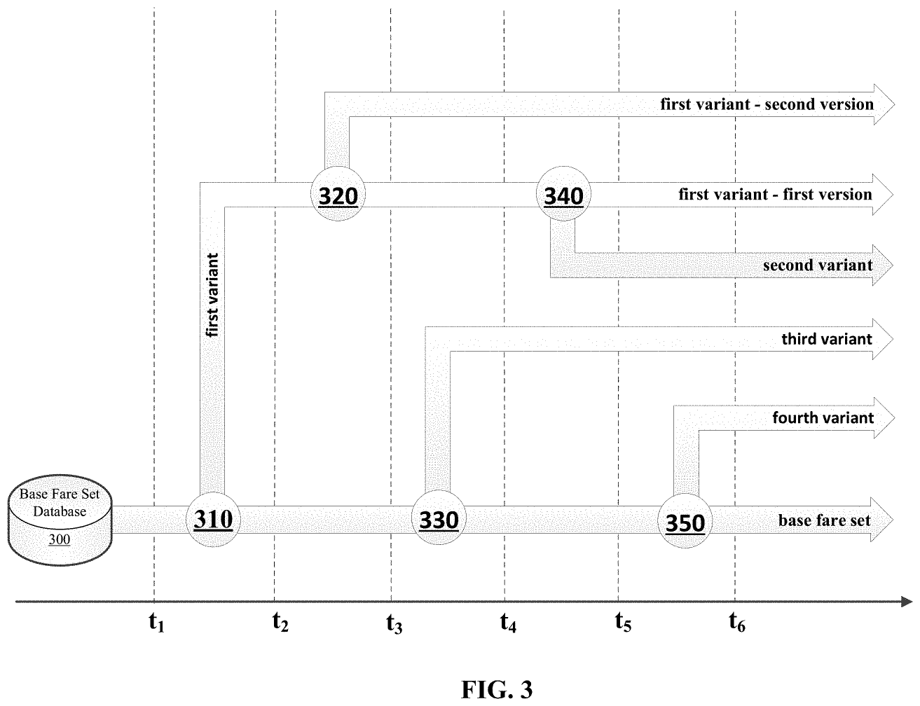

FIG. 3 depicts a high-level illustration of parallel content versioning at different points in time in accordance with an embodiment of the present invention. In an embodiment, the parallel content versioning technique depicted in FIG. 3 may be effectuated by versioning handler 213 of FIG. 2. Each line depicted in FIG. 3 represents an independent fare set that is currently accessible to a content server (e.g., content server 150 of FIG. 1 and reservation system 200 of FIG. 2) and the occurrence of a branching operation is designated by a circle.

As shown, parallel content versioning occurs with respect to an original content source storing original (i.e., unmodified) content data. In this example, the original content source is a base fare set database 300 storing base fare set data. One skilled in the art will recognize that the present invention is equally applicable to original content sources storing other types of original content data. Examples of such other types of original content data include image data, audio data, video data, text data, and the like.

At time “t₁”, only one version of a fare set (i.e., the base fare set) is currently accessible to the content server. Subsequent to time “t₁”, branching operation 310 occurs and a first modified fare set is created that includes a first variant. As a result of branching operation 310, two versions of the fare set are concurrently accessible to the content server, at time “t₂”. Following time “t₂”, branching operation 320 occurs and a second modified fare set is created that includes a second version of the first variant. As a result of branching operation 320, three versions of the fare set are concurrently accessible to the content server, at time “t₃”.

Each parallel version of the fare set may independently evolve over time as illustrated by branching operation 330, branching operation 340, and branching operation 350. Such independent evolution may involve modifying the base fare set with different variants, as illustrated by branching operations 330 and 350 in which the base fare set is modified by a third variant and a fourth variant, respectively. Such independent evolution may also involve further modifying the modified fare sets with additional variants, as illustrated by branching operation 340 in which the first modified fare set is further modified with a second variant. Regardless of how such independent evolution occurs, similar results follow—additional versions of the fare set are concurrently available to the content server. For example, four versions of the fare set are concurrently accessible to the content server at time “t₄”, five versions of the fare set are concurrently accessible at time “t₅”, and six versions of the fare set are concurrently accessible at time “t₆” following branching operations 330, 340, and 350, respectively.

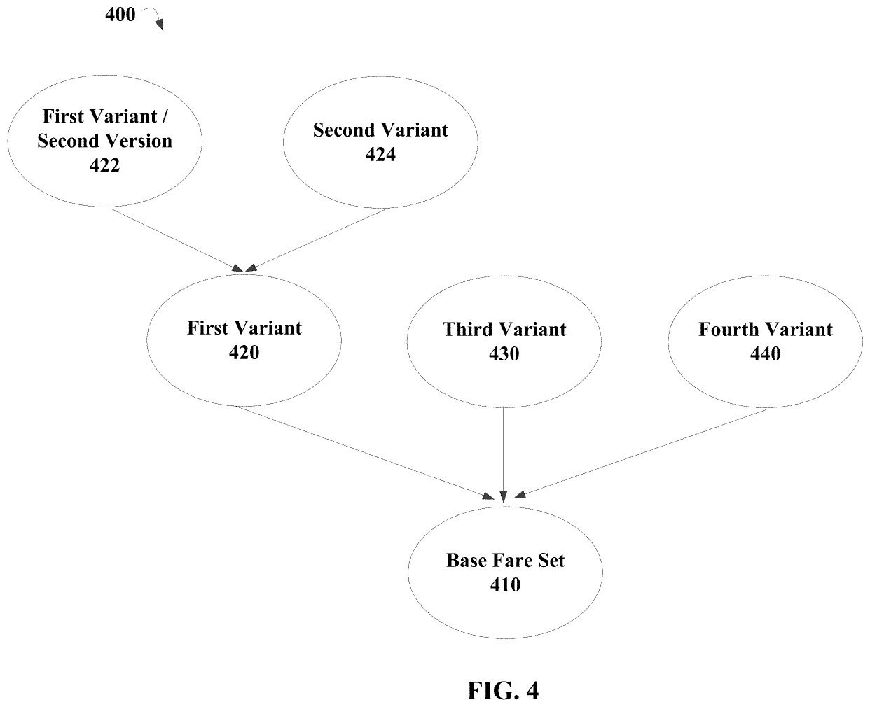

FIG. 4 depicts a high-level illustration of a data structure 400 that is suitable for implementing parallel content versioning in accordance with an embodiment of the present invention. As discussed above with respect to FIG. 2, parallel versions of a fare set may be treated as independent fare sets by creating a child file when a branching operation occurs. To facilitate that independent treatment, data structure 400 is composed of a plurality of discrete data elements, objects, or files (“files”) (i.e., files 410, 420, 422, 424, 430, and 440). In other words, each file among the plurality of files included in data structure 400 is processed as an atomic unit of data.

Generally, each file among the plurality of files composing data structure 400 represents either a current state of a modified fare set relative to a state of a parent fare set when the modified fare set was created or a current state of a base fare set. For example, file 420 represents a current state of a first modified fare set whereas file 410 represents a current state of a base fare set. If the first modified fare set is distinct from other versions of the fare set by virtue of a first variant, file 420 stores data corresponding to the first variant. With reference to FIG. 3, file 420 is created by a versioning handler (e.g., versioning handler 213 of FIG. 2) concurrent to branching operation 310.

As another example, files 430 and 440 represent a current state of a fourth fare set and a fifth fare set, respectively. If the fourth modified fare set is distinct from other versions of the fare set by virtue of a third variant and the fifth modified fare set is distinct from other versions of the fare set by virtue of a fourth variant, files 430 and 440 that store data corresponding to the third and fourth variants, respectively. With reference to FIG. 3, files 430 and 440 are created by the versioning handler concurrent to branching operations 330 and 350, respectively.

As shown by FIG. 4, a modified fare set may have another modified fare set as a parent fare set that enables further modification of modifications to a base fare set. For example, files 422 and 424 represent a current state of a second modified fare set and a third modified fare set, respectively, with each modified fare set having another modified fare set (i.e., the first modified fare set) as a parent fare set. These further modifications facilitate independent evolution of the modified fare sets. Such independent evolution may include instantiating different versions of a modification to a base fare set. In the embodiment of FIG. 4, this is depicted by file 422 that stores data corresponding to a second version of the first variant. Such independent evolution may also include varying different aspects of the base fare set. In the embodiment of FIG. 4, this is depicted by files 430 and 440 that store data corresponding to the third and fourth variants, respectively.

In an embodiment, the versioning handler concurrently creates an image of a file representing a state of a parent fare set when a modified fare set is created. For example, the versioning handler may concurrently create an image of file 410 to capture a current state of the base fare set when file 420 is created. As another example, the versioning handler may concurrently create an image of file 420 to capture a current state of the first modified fare set when file 422 is created. In an embodiment, the versioning handler concurrently creates a read-only copy of a file representing a state of a parent fare set when a modified fare set is created. For example, the versioning handler may concurrently create an image of file 410 to capture a current state of the base fare set when file 430 is created. As another example, the versioning handler may concurrently create an image of file 420 to capture a current state of the first modified fare set when file 424 is created. In an embodiment, the versioning handler concurrently creates a read-write copy of a file for a parent fare set when a modified fare set is created to capture any subsequent modifications to the parent fare set.

Upon creating a file that represents a current state of a modified fare set, the versioning handler populates the file with metadata. Such metadata may include information regarding the modified fare set or its parent fare set. For example, the metadata may include an identify of the parent fare set, location information for a file associated with the parent fare set, any pertinent versioning information (e.g., a version number of the parent fare set), a time stamp associated with a branching operation that resulted in the modified fare set, descriptive data regarding a variant of the modified fare set, and the like.

In an embodiment, the versioning handler compiles a modified fare set in response to receiving a value it receives from a fare data handler (e.g., fare data handler 217 of FIG. 2) corresponds to the modified fare set. In an embodiment, the value includes location information for a file representing a current state of the modified fare set. In an embodiment, the value from a fare data handler (e.g., fare data handler 217 of FIG. 2) based on a unique identifier associated with a search query. Using metadata retrieved from the file representing the current state of the modified fare set, the versioning handler locates a file associated with its parent fare set. If that parent fare set is not a base fare set, the versioning handler locates a file associated with a parent fare set of that fare set using metadata retrieved from its associated file until a file associated with the base fare set is located. Upon locating the file associated with the base fare set, the versioning handler parses data retrieved from that chain of files to compile the modified fare set.

For example, when compiling the second modified fare set, the versioning handler may receive a value that describes a location of file 422. Using metadata retrieved from file 422, the versioning handler may locate file 420 (or an image/read-only copy of file 420 created concurrent to branching operation 320 of FIG. 3). Since file 420 corresponds to the first modified fare set and not the base fare set, the versioning handler locates file 410 (or an image/read-only copy of file 410 created concurrent to branching operation 310 of FIG. 3) that corresponds to the base fare set. The versioning handler may then parse data retrieved from file 422 along with data retrieved from files 420 and 410 (or the corresponding image/read-only copies) to compile the second modified fare set.

In an embodiment, fare data is retrieved from a file representing a current state of a modified fare set without compiling the modified fare set using metadata of the file. That is, fare data may be directly retrieved from the file without the versioning handler creating a full-version of the modified fare set. In this embodiment, the fare data is retrieved by analyzing the metadata to determine whether the file includes pricing information for a travel itinerary that satisfies search parameters received from a client submitting a search query. If analysis of the metadata determines that such pricing information is included in the file, the fare data is directly retrieved from the file. If analysis of the metadata determines that such pricing information is not included in the file, a parent file associated with a parent fare set of the modified fare set is located using the metadata. This process continues until an analysis of metadata of a parent file indicates that such pricing information is included in the parent file.

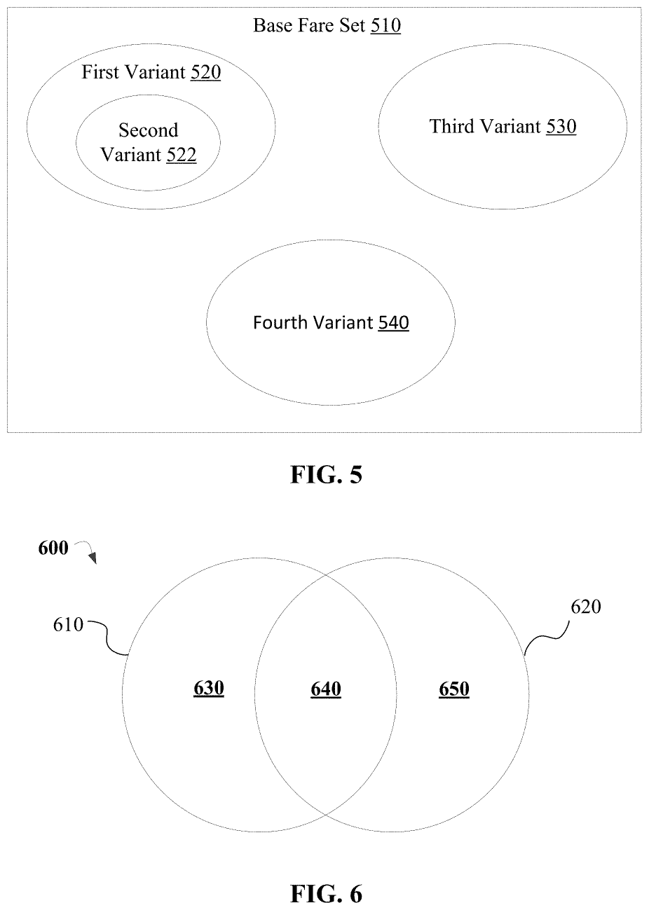

FIG. 5 illustrates an example of relationships between base fare set data 510 and variants of base fare set data 510 in accordance with an embodiment of the present invention. In FIG. 5, base fare set data 510 represents data stored in a base fare set database (e.g., base fare set database 265 and/or 300 of FIGS. 2 and 3, respectively). Moreover, each variant data in FIG. 5 represents data stored in a file associated with a modified fare set. That is, with reference to FIG. 4, first variant data 520 represents data stored in file 420, second variant data 522 represents data stored in file 424, third variant data 530 represents data stored in file 430, and fourth variant data 540 represents data stored in file 440.

As shown, the variant data stored in a file associated with a particular modified fare set corresponds to a subset of base fare set data 510. This facilitates the introduction of narrowly defined changes that modify particular aspects of base fare set data 510. For example, if base fare set data 510 corresponds to fare data for all routes serviced by a rail carrier in Europe, first variant data 520 may define changes to fare data for a Paris to Nice route. In this instance, fare data for a Paris to Lille route serviced by the rail carrier would remain unchanged by first variant data 520. Changes to the Paris to Lille route may be defined by third variant data 530.

Besides defining changes to fare data for particular routes, variant data may also define changes to fare data for other aspects of base fare set data 510. Such other aspects may include: regions of travel (e.g., routes in Germany), a range of travel times (e.g., travel itineraries involving overnight travel), fare classes (e.g., economy class), passenger subsets (e.g., senior passengers or children passenger), and the like. Continuing with the previous example, fourth variant data 540 may define changes to fare data for senior passengers.

In addition to introducing changes that directly modify particular aspects of base fare set data 510, variant data may also introduce changes that indirectly modify base fare set data 510. Such changes may be implemented by variant data that defines changes that further modify particular aspects of another modified fare set. Using the previous example, second variant data 522 may define changes to fare data for senior passengers on the Paris to Nice route. This further reduces the granularity of changes made by variant data to base fare set data 510.

Variant data may also define different versions of such changes. With reference to FIG. 4, file 422 stores data corresponding to a second version of the first variant. In that instance, if first variant data 520 represents data stored in file 420, the data stored in file 422 would coincide with first variant data 520 in FIG. 5. Continuing with the previous example, first variant data 520 may define a first version of a fare data discount for a Paris to Nice route, such as a 50% discount. The data stored in file 422 may define a second version of the fare data discount for the Paris to Nice route, such as a buy-one/get-one-free offer. Under the buy-one/get-one-free offer, a client could purchase a first ticket for the Paris to Nice route at full price and receive a second ticket for that route at no cost.

In FIG. 5, the variant data corresponding to variants of base fare set data 510 (e.g., first variant 520, second variant 522, third variant 530, and fourth variant 540) are depicted as disjointed for simplification of illustrative purpose. In some embodiments, variant data corresponding to a variant of base fare set data 510 may intersect with two or more other variants in accordance with aspects of the present invention. For example, in accordance with an embodiment of the present invention, second variant 522 may intersect with both first variant 520 and third variant 530. In this example, second variant 522 may further modify particular aspects of both first variant 520 and third variant 530.

FIG. 6 depicts a Venn diagram 600 for illustrating the performance of set operations on parallel content versions in accordance with an embodiment of the present invention. As discussed above with respect to FIG. 2, each of the parallel versions of a fare set may be objectively evaluated using evaluation metrics determined for each version using compiled evaluation data. Based on that objective evaluation, a determination may be made that clients respond more positively to a first version of a fare set than a second version of the fare set. Upon making that determination, it may be desirable to fully or partially incorporate (i.e., merge) changes defined by variant data associated with that first version of the into a base fare set (or another version of the fare set).

Alternatively, that objective evaluation may determine that clients respond more positively to the second version of the fare set than the first version of the fare set. In that instance, it may be desirable to fully or partially roll back changes defined by variant data associated with that first version of the fare set when such variant data was incorporated into the base fare set (or another version of the fare set).

Such merging or roll back operations typically involve element-by-element comparisons between each fare set being merged. In contrast, embodiments of the present invention provide such merging or roll back operations using set operations performed on child files (e.g., files 420, 422, 424, 430, and 440 of FIG. 4). As child files store data corresponding to variants that define changes made to parent fare sets, those changes may be identified and merged or rolled back, as appropriate. Moreover, in as much as each child file has a corresponding parent file representing a particular version of the fare set prior to modification by a respective variant stored in that child file, the resulting parent-child relationships may improve data integrity as additional changes are introduced.

In FIG. 6, files 610 and 620 each store data corresponding to one version of a fare set among a plurality versions of the fare set. For example, files 610 and 620 may correspond to files 420 and 424 of FIG. 4, respectively. If a union operation is performed on files 610 and 620 to aggregate the data in both files, a resulting file would store data represented by regions 630, 640, and 650. If a difference operation is performed on files 610 and 620 to identify differences between those files, a resulting file would store data represented by regions 630 and 650. If an intersection operation is performed on files 610 and 620 to identify common data stored in both files, a resulting file would store data represented by region 640. One skilled in the art will recognize that other set operations beyond the particular set operations disclosed herein may be performed on files 610 and 620 without departing from the spirit of the present invention. In an embodiment, the set operation techniques described with respect to FIG. 6 may be effectuated by versioning handler 215 of FIG. 2.

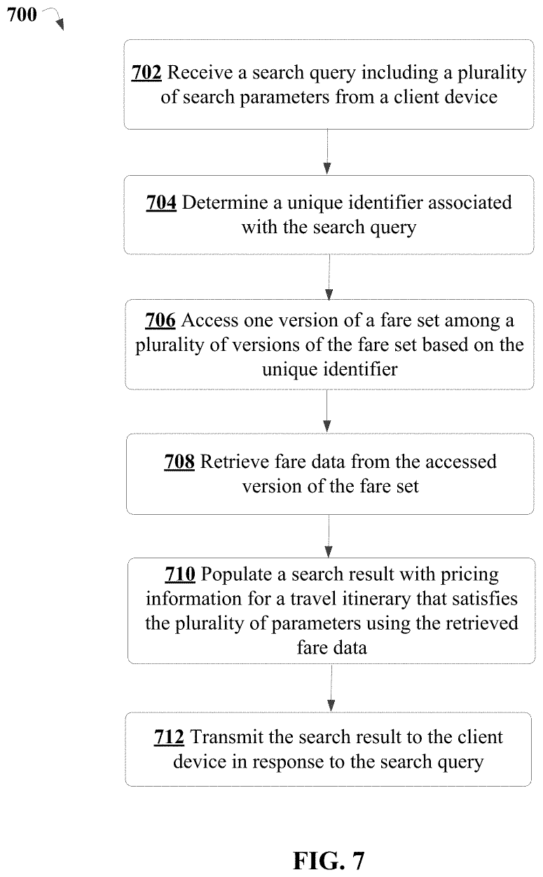

FIG. 7 depicts an embodiment of a method 700 for channel-dependent testing parallel versions of content in a distributed computing environment. In an embodiment, method 700 may be effectuated by reservation system 200 of FIG. 2, as it generates a unique identifier for a received search query. At block 702, a search query including a plurality of search parameters is received from a client device. In an embodiment, block 702 may be effectuated by web service 211 of FIG. 2. In an embodiment, the search query is an API call directed to an API of a reservation system. In an embodiment, the client device is a user device. In an embodiment, the client device is a web client (e.g., an application server, a search web site, and/or a terminal server) associated with a user device. In an embodiment, the plurality of search parameters correspond to a travel request for a customer. In an embodiment, the plurality of search parameters include a rail segment number, a departure date, an arrival date, a point of origin, a destination, a number of stops, a booking class, a cabin class, a point of sale, a number in party, a RFSIC, or a combination thereof.

At block 704, a unique identifier associated with the search query is determined. In an embodiment, block 704 may be effectuated by routing handler 213 of FIG. 2. In an embodiment, the unique identifier is determined using the plurality of search parameters. In an embodiment, the unique identifier is determined using a cookie stored on the client device. In an embodiment, the unique identifier is determined using a network address associated with the client device, a machine address of a component included in the client device, a user ID of a user associated with the client device, an office ID of a business entity associated with the client device, log-in credentials provided in establishing a communication session between the reservation system and the client device, information provided by a plugin running in a deployment of an application associated with the client device, or a combination thereof.

At block 706, one version of a fare set among a plurality of versions of the fare set is accessed based on the unique identifier. Each version of the fare set among the plurality of versions of the fare set is distinct from other versions of the fare set by virtue of a variant. In an embodiment, the variant defines changes to fare data for a subset of base fare set data. In an embodiment, the subset of the base fare set data corresponds to a particular route serviced by a travel provider associated with the base fare set data, a region of travel serviced by the travel provider, a range of travel times, a cabin class offered by the travel provider, a subset of passengers, and the like. In an embodiment, the variant defines a different version of another variant. In an embodiment, the accessed version of the fare set is a modified fare set. In an embodiment, the accessed version of the fare set is a base fare set. In an embodiment, data is cached in a storage device associated with the reservation system that associates the unique identifier with the accessed version of a fare set. In an embodiment, the cached data includes time-stamp information indicating a receipt time of the search query, an access time of the accessed version of the fare set, a time the data is cached, or a combination thereof. In an embodiment, block 706 is effectuated by versioning handler 215 of FIG. 2. In an embodiment, block 706 is effectuated by fare data handler 217 of FIG. 2.

At block 708, fare data is retrieved from the accessed version of the fare set. In an embodiment, the fare data is retrieved from a modified fare set compiled by a versioning handler before the search query is received from the client device. In an embodiment, the fare data is directly retrieved from a child file storing data corresponding to a variant of a modified fare set by examining metadata associated with the child file. In an embodiment, the fare data is directly retrieved from a parent image storing data representing a state of a parent fare set when the modified fare set was branched from the parent fare set by examining metadata associated with the parent image. In an embodiment, block 708 is effectuated by fare data handler 217 of FIG. 2. At block 710, a search result is populated with pricing information for a travel itinerary that satisfies the plurality of search parameters using the retrieved fare data. In an embodiment, block 710 is effectuated by routing handler 213 of FIG. 2. At block 712, the search result is transmitted to the client device in response to the search query. In an embodiment, web service 211 effectuates block 712.

Having described various embodiments of the invention, an exemplary computing environment suitable for implementing embodiments of the invention is now described. With reference to FIG. 8, a block diagram of an example computing device is provided and referred to generally as computer system 800. User device 110, application server 120, search website 130, terminal server 140, content server 150, reservation system 200, and any component of reservation system 200 may be implemented on one or more computer devices or systems, such as exemplary computer system 200. The computer system 200 may include a processor 826, a memory 828, a mass storage memory device 830, an input/output (I/O) interface 832, and a Human Machine Interface (HMI) 834. The computer system 800 may also be operatively coupled to one or more external resources 836 via the network 823 or I/O interface 832. External resources may include, but are not limited to, servers, databases, mass storage devices, peripheral devices, cloud-based network services, or any other suitable computer resource that may be used by the computer system 800.

The processor 826 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 828. The memory 828 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 830 may include data storage devices such as a hard drive, optical drive, tape drive, non-volatile solid state device, or any other device capable of storing information.

The processor 826 may operate under the control of an operating system 838 that resides in the memory 828. The operating system 838 may manage computer resources so that computer program code embodied as one or more computer software applications, such as an application 840 residing in memory 828, may have instructions executed by the processor 826. In an alternative embodiment, the processor 826 may execute the application 840 directly, in which case the operating system 838 may be omitted. One or more data structures 842 may also reside in memory 828, and may be used by the processor 826, operating system 838, or application 840 to store or manipulate data.

The I/O interface 832 may provide a machine interface that operatively couples the processor 826 to other devices and systems, such as the network 823 or the one or more external resources 836. The application 840 may thereby work cooperatively with the network 823 or the external resources 836 by communicating via the I/O interface 832 to provide the various features, functions, applications, processes, or modules comprising embodiments of the invention. The application 840 may also have program code that is executed by the one or more external resources 836, or otherwise rely on functions or signals provided by other system or network components external to the computer system 820. Indeed, given the nearly endless hardware and software configurations possible, persons having ordinary skill in the art will understand that embodiments of the invention may include applications that are located externally to the computer system 820, distributed among multiple computers or other external resources 836, or provided by computing resources (hardware and software) that are provided as a service over the network 823, such as a cloud computing service.

The HMI 834 may be operatively coupled to the processor 826 of computer system 820 in a known manner to allow a user to interact directly with the computer system 820. The HMI 834 may include video or alphanumeric displays, a touch screen, a speaker, and any other suitable audio and visual indicators capable of providing data to the user. The HMI 834 may also include input devices and controls such as an alphanumeric keyboard, a pointing device, keypads, pushbuttons, control knobs, microphones, etc., capable of accepting commands or input from the user and transmitting the entered input to the processor 826.

A database 844 may reside on the mass storage memory device 830, and may be used to collect and organize data used by the various systems and modules described herein. The database 844 may include data and supporting data structures that store and organize the data. In particular, the database 844 may be arranged with any database organization or structure including, but not limited to, a relational database, a hierarchical database, a network database, or combinations thereof. A database management system in the form of a computer software application executing as instructions on the processor 826 may be used to access the information or data stored in records of the database 844 in response to a query, where a query may be dynamically determined and executed by the operating system 838, other applications 840, or one or more modules.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed:

1. A method comprising:
receiving, from a client device, a search query including a plurality of search parameters;
identifying a search result that satisfies the plurality of search parameters, the search result comprising a travel itinerary;
determining a unique identifier associated with the search query;
accessing one version of a fare set among a plurality of versions of the fare set based on the unique identifier, each version of the fare set among the plurality of versions of the fare set being distinct from the other versions by virtue of a variant, each variant being stored in a corresponding child file, each child file having a corresponding parent file representing a particular version of the fare set prior to modification by a respective variant;
retrieving fare data from the accessed version of the fare set;
populating the search result with pricing information for the travel itinerary using the retrieved fare data; and
transmitting the search result to the client device in response to the search query.

2. The method of claim 1, wherein the plurality of versions of the fare set include a first modified fare set and a second modified fare set that are distinct from the other versions of the fare set by virtue of a first variant, the first modified fare set includes a first version of the first variant, and the second modified fare set includes a second version of the first variant.

3. The method of claim 2, further comprising:
determining a first evaluation metric for the first modified fare set; and
determining a second evaluation metric for the second modified fare set.

4. The method of claim 3, further comprising:
merging one of the first version and the second version of the first variant into a base version of the fare set based upon a comparison between the first evaluation metric and the second evaluation metric.

5. The method of claim 3, further comprising:
discarding one of the first modified fare set and the second modified fare set based upon a comparison between the first evaluation metric and the second evaluation metric.

6. The method of claim 3, wherein the first evaluation metric and the second evaluation metric are conversion rates indicative of a percentage of travel itinerary bookings respectively associated with the first version and the second version of the first variant.

7. The method of claim 2, wherein the plurality of versions of the fare set further include a third modified fare set that is distinct from the other versions of the fare set by virtue of a second variant, and the third modified fare set corresponding to a sub-set of the first modified fare set.

8. The method of claim 7, further comprising:
performing a set operation on the first modified fare set and the third modified fare set to generate a fourth modified fare set.

9. The method of claim 8, wherein the set operation includes a union set operation, an intersection set operation, a difference set operation, or a combination thereof.

10. The method of claim 1, wherein the unique identifier is determined based on the plurality of search parameters, user login credentials, an account identifier, a machine identifier of the client device, a network address of the client device, a geographic location of the client device, or a combination thereof.

11. The method of claim 1, further comprising:
caching search-related data that associates the unique identifier, the search query, the accessed version of the fare set, the search response, or a combination thereof in a storage device associated with a reservation system.

12. The method of claim 1, wherein the search query is an application program interface (API) call directed to an API of a reservation system.

13. A system comprising:
a computing device; and
a computer-readable storage medium comprising a first set of instructions that upon execution by the computing device cause the system to:
receive, from a client device, a search query including a plurality of search parameters;
determine a unique identifier associated with the search query;
access one version of a fare set among a plurality of versions of the fare set based on the unique identifier, each version of the fare set among the plurality of versions of the fare set being distinct from the other versions of the fare set by virtue of a variant, each variant being stored in a corresponding child file, each child file having a corresponding parent file representing a particular version of the fare set prior to modification by a respective variant;
retrieve fare data from the accessed version of the fare set;
populate a search result with pricing information for a travel itinerary that satisfies the plurality of search parameters using the retrieved fare data; and
transmit the search result to the client device in response to the search query.

14. The system of claim 13, wherein the plurality of versions of the fare set includes a first modified fare set that is distinct from the other versions of the fare set by virtue of a first variant, and the first modified fare set includes a first child file storing data corresponding to the first variant.

15. The system of claim 14, wherein the first modified fare set further includes a parent image storing data representing a state of a parent fare set when the first modified fare set was branched from the parent fare set.

16. The system of claim 14, wherein the computer-readable storage medium further comprises a second set of instructions that upon execution by the computing device further cause the system to:
execute a branching operation to create a second modified fare set including a second version of the first variant, the second modified fare set including a second child file storing data corresponding to the second version of the first variant.

17. The system of claim 16, wherein the second modified fare set further includes a parent image storing data representing a state of the first modified fare set when the second modified fare set was created by executing the branching operation.

18. The system of claim 13, wherein the plurality of versions of the fare set include a base fare set and a first modified fare set created by executing a branching operation on the base fare set.

19. The system of claim 18, the computer-readable storage medium further comprises a second set of instructions that upon execution by the computing device further cause the system to:
determine an evaluation metric for each version of the fare set among the plurality of versions of the fare set; and
merge a first variant of the first modified fare set into the base fare set using a first child file storing data corresponding to the first variant based on the evaluation metric determined for each version of the fare set.

20. A non-transitory computer-readable storage medium comprising computer-readable instructions that upon execution by a processor of a computing device cause the computing device to:
receive a search query including a plurality of search parameters from a client device;
determine a unique identifier associated with the search query;
access one version of a fare set among a plurality of versions of the fare set based on the unique identifier, each version of the fare set among the plurality of versions of the fare set being distinct from the other versions by virtue of a variant, each variant being stored in a corresponding child file, each child file having a corresponding parent file representing a particular version of the fare set prior to modification by a respective variant;
retrieve fare data from the accessed version of the fare set;
populate a search result that satisfies the plurality of search parameters with pricing information for a travel itinerary using the retrieved fare data; and
transmit the search result to the client device in response to the search query.
